(19) United States
(12) Patent Application Publication
(10) Pub. No.: US 2024/0397876 A1
(43) Pub. Date: Dec. 5, 2024

(54) ROUND BALER AND METHOD

(71) Applicant: DEERE & COMPANY, MOLINE, IL (US)

(72) Inventor: AURELIEN CHABASSIER, BROYE LES LOUPS (FR)

(21) Appl. No.: 18/620,122

(22) Filed: Mar. 28, 2024

(30) Foreign Application Priority Data
Jun. 5, 2023 (DE) 102023114691.2

(51) Int. Cl. A01F 15/08; A01F 15/07

(52) U.S. Cl. CPC A01F 15/0833; A01F 15/07; A01F 2015/078

(57) ABSTRACT

A round baler for forming a cylindrical bale includes a frame which is supported on the ground via a chassis, and a housing having a baling means, e.g., baling belts, that defines a baling chamber of variable diameter. The round baler includes a first sensor device for determining a weight of the bale, a second sensor device for determining a diameter of the bale, and a baler controller, by means of which at least a diameter and a weight of a finished bale may be specified. A method for operating the round baler includes controlling the round baler to produce a bale having the pre-selected diameter and weight.

### CROSS-REFERENCE TO RELATED APPLICATIONS

This application claims the benefit of German Patent Application DE102023114691.2, filed on Jun. 5, 2023, the disclosure of which is hereby incorporated by reference.

### TECHNICAL FIELD

The disclosure generally relates to a round baler for forming a substantially cylindrical bale, and a method of operating the round baler.

### BACKGROUND

Round balers are used to pick up baling material and to shape this into cylindrical bales. Such round balers are frequently used in agriculture for retrieving straw or hay that has been deposited on the ground in swaths.

Round balers with a variable baling chamber can produce bales of different diameters. This diameter is usually specified before the formation of the bale. Depending on the ambient conditions, for example the moisture content and/or composition of the crops, bales can have a different weight despite having the same diameter. This is often disadvantageous when selling, since bales with the same weight and a uniform diameter are desired or ordered by customers.

### SUMMARY

A round baler for forming an at least substantially cylindrical bale is provided. The round baler includes a frame, which is supported on the ground via a chassis, and a housing with a baling means that defines a baling chamber of variable diameter. Also provided are at least one first sensor device for determining the weight of the bale, and a control unit by means of which at least the diameter of a finished bale can be specified. By means of the control unit, the weight of a finished bale can be specified in addition to the diameter, so that bales of both uniform diameter and uniform weight can be formed using the round baler. Such round balers are usually used in agriculture to form round cylindrical bales of crops, for example straw, hay or silage, which are picked up from the ground by means of a crop pick-up device and fed to the baling chamber. It is conceivable for a round baler to be self-driving, but round balers are usually hitched to a towing vehicle and towed by same. A towing vehicle can be a tractor, for example.

In one implementation, the control unit controls or regulates at least one machine parameter depending on an output of the first sensor device. The machine parameter may include, but is not limited to, a baling pressure exerted by the baling means on the bale to be formed. However, it can alternatively or additionally be provided for the control unit to control or regulate at least one bale parameter depending on an output of the first sensor device, wherein the bale parameter is preferably the bale density.

A particularly simple construction results when the first sensor device is provided on the chassis and/or the first sensor device determines at least the weight of the housing with a bale located therein. The chassis can for example have one or more axles on which wheels, but also runners or tracks or other suitable means, are mounted, preferably rotatably.

The first sensor device can be designed in the manner of a strain gauge and/or have at least one strain gauge. For example, the strain gauge can be provided on the chassis or an axle of the round baler or interact with same. The strain gauge(s) can also be part of a load cell.

In addition to the first sensor device, a further sensor device, e.g., a second sensor device, can be provided. This second sensor device is used to determine the current diameter of the bale located in the baling chamber and preferably transmits an output value representing the diameter to the control unit. The second sensor device can for example be one or more ultrasonic sensors, or the sensor unit can have such sensors. Alternative designs are however also conceivable.

According to a method for operating an above-described round baler, a diameter and a weight of a finished bale are preselected by means of the control unit. During bale formation, the current weight and the diameter of the bale are determined by the sensor devices, wherein the control unit controls or regulates at least one machine parameter and/or a bale parameter depending on the output of the sensor devices. This can take place once or multiple times, for example at regular time intervals and/or for example automatically when the control unit receives that the output values of the sensor unit(s) differ from predefined/specified values.

The machine parameter and/or bale parameter can be a baling pressure and a bale density, respectively. For example, the density of the bale and thus the weight of the bale can be increased by increasing the baling pressure. If the baling pressure is reduced, the density of the bale can be reduced and thus the weight of the bale can be reduced.

It is particularly favourable when the currently determined diameter and weight of the bale are referenced to the preselected diameter and weight of the finished bale in the control unit. To this end, at least one reference dataset can preferably be stored in the control unit. The reference dataset can contain corresponding values for a ratio of diameter to weight of the bale being formed for the preselected weight and diameter of the bale. It can be provided for a reference dataset to contain reference values for different crops and/or harvesting conditions. However, it is also conceivable to provide different reference datasets. The formation of the bale can be controlled/regulated correspondingly. The formation of the bale or the machine/bale parameters can be regulated or controlled corresponding to the specifications of the reference dataset(s). For example, the bale density or the baling pressure can be reduced when an excessively high weight is determined or increased when the weight of the bale is too low in relation to the present diameter.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a round baler having a plurality of rolls arranged in a housing, a baling means wrapping around the rolls, and a baler controller.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

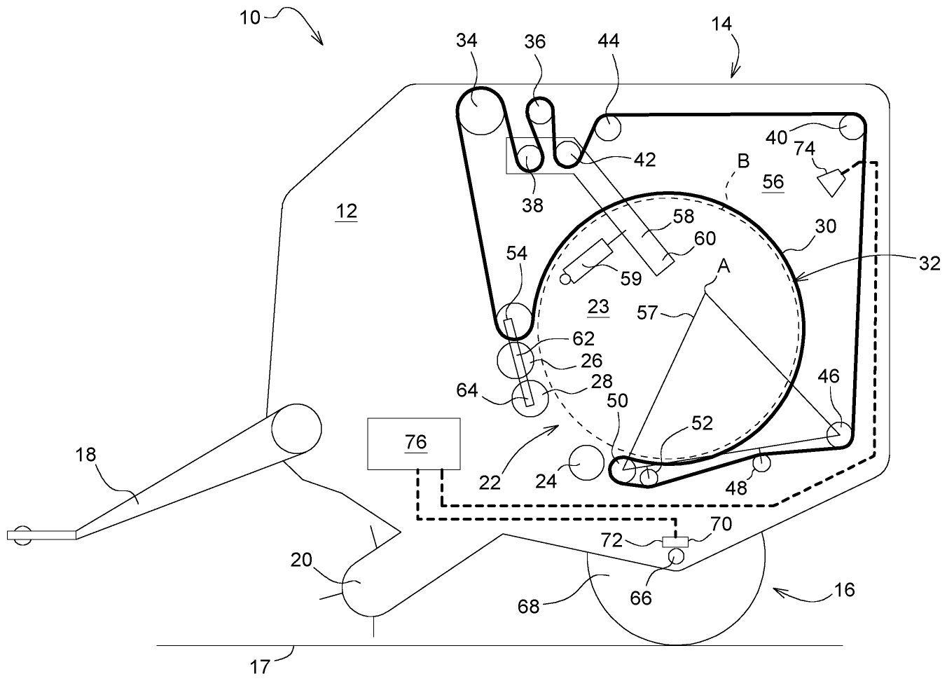

Referring to the Figures, wherein like numerals indicate like parts throughout the several views, a round baler is generally shown at 10. Referring to FIG. 1, the round baler 10 is configured for forming a bale B having a cylindrical shape. The round baler 10 has a housing 12 and a frame 14, which is supported on the ground 17 via a chassis 16. Arranged on the front side of the frame 14 is a drawbar 18 in order to be able to hitch the round baler 10 to a towing vehicle (not shown), for example a tractor, and to tow it over a field. Furthermore, a device for controlling and/or regulating the round baler or for monitoring a bale formation process is provided, which device is shown only in outline and will be referred to in the remainder of the description as the baler controller 76. By means of the baler controller 76, which will be discussed in more detail below, parameters/functions of the round baler 10 and/or of the bale B or of the bale formation, for example, can be preselected.

While the baler controller 76 is generally described herein as a singular device, it should be appreciated that the baler controller 76 may include multiple devices linked together to share and/or communicate information therebetween. Furthermore, it should be appreciated that the baler controller 76 may be located on the round baler 10 or located remotely from the round baler 10.

The baler controller 76 may alternatively be referred to as a computing device, a computer, a controller, a control unit, a control unit ECU, a control module, a module, etc. The baler controller 76 includes a processor, a memory, and all software, hardware, algorithms, connections, sensors, etc., necessary to manage and control the operation of the round baler 10. As such, a method may be embodied as a program or algorithm operable on the baler controller 76.

As used herein, “controller” is intended to be used consistent with how the term is used by a person of skill in the art, and refers to a computing component with processing, memory, and communication capabilities, which is utilized to execute instructions (i.e., stored on the memory or received via the communication capabilities) to control or communicate with one or more other components. In certain embodiments, the baler controller 76 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The baler controller 76 may be in communication with other components on the round baler 10, such as hydraulic components, electrical components, and operator inputs within an operator station of an associated work vehicle. The baler controller 76 may be electrically connected to these other components by a wiring harness such that messages, commands, and electrical power may be transmitted between the baler controller 76 and the other components.

A picking-up apparatus 20 in the form of a pick-up is used to pick up crops lying on the ground, for example hay or straw deposited in a swath. The crops picked up by the picking-up apparatus 20 are fed to the inlet 22 of a baling chamber 23 and rolled up spirally therein to form a round cylindrical bale B (shown only in outline), tied and then deposited on the ground. Positioned at the inlet 22 of the baling chamber 23 are a lower, stationary roller 24 and two upper rollers 26, 28. The baling chamber 23 is also formed by an endless baling means 30 in the form of two baling belts 32 that lie laterally immediately adjacent to one another and are guided around a number of rolls 34-54. However, it is also conceivable to design baling means 30 in one piece or alternatively also to provide more than two baling belts 32. While the baling chamber 23 is substantially surrounded circumferentially by the baling means 30 and the rollers 24 to 28, it is delimited laterally by side walls 56.

Four of the rollers 46 to 52 are mounted freely rotatably at the lower end of a delta-shaped carrier 57, which is hinged so as to be pivotable by way of its upper tip about an axis of rotation A extending horizontally and transversely to the forward direction and is able to be moved by means of an actuator (not shown) from the bale-forming position illustrated in FIG. 1 into a rearwardly and upwardly pivoted bale ejection position.

A tensioning arm 58, which has two rolls 38, 42 arranged in a radially outwardly movable manner on the tensioning arm 58, and a tensioning element 59 are provided to tension the baling means 30. The tensioning arm 58 is mounted in a bearing 60 in the region of the side walls 38 above and in front of the axis of rotation A so as to be pivotable about an axis extending horizontally and transversely to the forward direction and extends under the plane in which the positionally fixed upper rolls 34, 36, 44 are arranged. The tensioning element 59 may be designed as a hydraulic cylinder or other similar linearly extendable element in a conventional manner.

The upper rollers 26, 28 and the roll 54 are fastened to a pivotable pivoting frame 64, which is mounted in its central region about a shaft 62 extending horizontally and transversely to the forward direction. The roll 54 and the rollers 26, 28 are mounted so as to be freely rotatable in the pivoting frame 64, wherein the roller 26 extends coaxially with the shaft 62. The pivoting frame 64 may be preloaded into a particular position by means of a tensioning element that is not shown.

The baling means 30 is always placed firmly against the rotationally driven, positionally fixed roll 34 by means of the tensioning arm 58 so as to ensure that it is entrained. The roll 54 is also driven in rotation. The baling means 30 adopts a starting state in which, in a stretched-out state, it bridges the inlet 22, and a final state in which it wraps in the manner of a large loop around the bale 36, approximately as shown in FIG. 1. The baling chamber 23 thus has a variable size, i.e., its diameter increases with the size of the bale. While it is being formed, the bale is located in the baling chamber 23 with the baling means 30 wrapped around it but drops rearwardly out of the baling chamber 23 onto the ground as soon as the carrier 57 with the movable rolls 46 to 52 pivots upward in an anticlockwise direction as seen in the drawing.

Reference is now made again to the frame 14 of the round baler 10 and the chassis 16. According to the present exemplary embodiment, the chassis 16 has an axle 66, which is mounted on the frame 14. Wheels 68 are mounted rotatably on the axle 66 and are in contact with the ground 17. A sensor device 70 is also provided on the axle 66.

The sensor device 70 is provided to determine the current weight of the bale B being formed or already formed and located in the baling chamber 23. To this end, the sensor device 70 preferably has at least one weighing device 72, in particular in the manner of a load cell and/or one or more strain gauges. The strain gauge(s) can also be part of the load cell. The sensor device 70 and/or the weighing device 72 is connected to the baler controller 76 of the round baler 10 in order to transmit output values to same for evaluation.

Since the entire frame 14 of the round baler 10 is supported on the ground 17 via the chassis 16 and via the axle 66 and ultimately the wheels 68, the chassis 16 or the axle bears the weight of the housing 12, the frame 14 and the bale B located in the baling chamber 23. The weighing device 72 thus senses the total weight of the frame 14, housing 12 and bale B, so that the sensor device 70 can transmit a corresponding output value to the baler controller 76 for evaluation and further processing. Furthermore, a further sensor device 74 is provided, which determines the diameter of the bale B located in the baling chamber 23 in a known manner, for example using one or more ultrasonic sensors. The output value of this further sensor device 74 is also transmitted to the baler controller 76 for evaluation and further processing.

A corresponding method for operating an above-described round baler 10 will now also be discussed. Settings, for example parameters and/or functions of the round baler 10 or of the bale formation, can be set or preselected on the baler controller 76 of the round baler 10, preferably before or at the start of the formation of a bale B. These settings can be made for example by an operator directly on the baler controller 76. However, it can also be provided for the settings to be made on the baler controller 76 by means of a corresponding input unit (not shown), which can be provided for example on the towing vehicle, or else by remote data transmission.

According to the present exemplary embodiment, in particular the diameter and the weight of a finished bale B can be preselected. During the formation of the bale B, the output value of the sensor device 70 is used to determine the weight of the bale B. The output value of the sensor device 70 is transmitted to the baler controller 76 and is evaluated or processed by the latter. The output value can be corrected by a weight of the housing 12 and frame 14 by means of the sensor device 70 and/or the baler controller 76.

The output value or the corrected output value of the sensor device 70 is related by the baler controller 76 to an output value that corresponds to the current diameter of the bale B and is sensed by the further sensor device 74, preferably in an at least substantially staggered manner, and transmitted to the baler controller 76. To this end, at least one reference dataset can be stored in the control unit 10. Preferably, however, multiple reference datasets are stored, which make available the corresponding values for different crops and/or different harvesting conditions, which can be for example a differing crop moisture content, structure or else cutting length.

On the basis of the determined weight or diameter and the reference dataset, the baler controller 76 defines whether the weight and the diameter of the bale B being formed match the preselected weight and diameter of the bale B or whether the bale B would have an excessively low or excessively high weight with the preselected diameter or in the finished state. Correspondingly, the baler controller 76 determines or calculates whether a bale parameter, which is the bale density according to the present exemplary embodiment, or a machine parameter, in this case the baling pressure exerted on the bale B by the baling means 30, should be changed, in particular increased or reduced. Correspondingly, the baler controller 76 according to the exemplary embodiment shown controls or regulates the tensioning element 59 acting on the tensioning arm 58 of the baling means 30, which tensioning element is in this case in the form of a hydraulic cylinder to which hydraulic pressure can be applied correspondingly by means of a hydraulic system (not shown in detail) in order to move the tensioning arm 58 according to requirements. The above-described sequence can be carried out once, but preferably multiple times, or repeated at regular, in particular chronological intervals, during the formation of a bale.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A round baler comprising:
a frame, which is supported on the ground via a chassis;
a housing supporting a baling belt that defines a baling chamber having a variable diameter for forming a bale having a substantially cylindrical shape;
a first sensor device operable to determine a weight of the bale; and
a baler controller operable to receive an input specifying a desired diameter and a desired weight of a finished bale.

2. The round baler set forth in claim 1, wherein the baler controller is operable to control at least one machine parameter depending on an output of the first sensor device.

3. The round baler set forth in claim 1, wherein the at least one machine parameter includes a baling pressure exerted by the baling belt against the bale during formation of the bale.

4. The round baler set forth in claim 2, wherein the at least one machine parameter controls a density of the bale.

5. The round baler set forth in claim 1, wherein the first sensor device is disposed on the chassis and is operable to determine a weight of the housing with the bale located therein.

6. The round baler set forth in claim 1, wherein the first sensor device includes a strain gauge.

7. The round baler set forth in claim 1, further comprising a second sensor device operable to determine a diameter of the bale located in the baling chamber, wherein the second sensor device transmits an output value representing the diameter to the baler controller.

8. A method of operating a round baler, the method comprising:
preselecting a finished diameter and a finished weight of a bale with a baler controller;
determining a current weight of the bale with a first sensor device during formation of the bale;
determining a current diameter of the bale with a second sensor device during formation of the bale;
controlling at least one machine parameter based on at least one of the current weight of the bale during formation of the bale and the current diameter of the bale during formation of the bale to achieve the preselected finished diameter and finished weight of the bale when fully formed.

9. The method set forth in claim 8, wherein the machine parameter includes a baling pressure affecting a density of the bale.

10. The method set forth in claim 8, wherein the currently determined diameter and weight of the bale are referenced to the preselected diameter and weight of the finished bale in the baler controller, wherein at least one reference dataset is stored in the baler controller for this purpose.

11. A round baler comprising:
a chassis;
a housing supporting a baling belt that defines a baling chamber having a variable diameter for forming a bale therein having a substantially cylindrical shape;
a tensioning element engaging the baling belt and selectively controllable to control tension of the baling belt to affect a density of the bale within the baling chamber;
a first sensor device operable to sense a weight of the bale within the baling chamber;
a second sensor device operable to sense a diameter of the bale within the baling chamber;
a baler controller configured to:
receive an input specifying a desired diameter and a desired weight of a completed bale;
receive a sensor signal from the first sensor device indicative of the weight of the bale within the baling chamber during formation of the bale within the baling chamber prior to completion of the bale;
receive a sensor signal from the second sensor device indicative of the diameter of the bale within the baling chamber during formation of the bale within the baling chamber prior to completion of the bale; and
control the tensioning element during formation of the bale within the baling chamber and prior to completion of the bale such that the completed bale exhibits the desired diameter and the desired weight.

12. The round baler set forth in claim 11, wherein the first sensor device is disposed on the chassis and is operable to determine a weight of the housing with the bale located therein.

13. The round baler set forth in claim 12, wherein the first sensor device includes a strain gauge.
